(19) United States
(12) Patent Application Publication
(10) Pub. No.: US 2026/0082371 A1
(43) Pub. Date: Mar. 19, 2026

(54) MULTI-SLOT SUPPORT FOR SIDELINK TRANSMISSIONS IN THE UNLICENSED SPECTRUM

(71) Applicant: Apple Inc., Cupertino, CA (US)

(72) Inventors: Huaning Niu, San Jose, CA (US); Wei Zeng, Saratoga, CA (US); Dawei Zhang, Saratoga, CA (US); Sigen Ye, San Diego, CA (US); Chunxuan Ye, San Diego, CA (US); Haitong Sun, San Jose, CA (US); Weidong Yang, San Diego, CA (US); Hong He, San Jose, CA (US)

(21) Appl. No.: 19/107,875

(22) PCT Filed: Sep. 1, 2023
(86) PCT No.: PCT/US2023/031855

§ 371 Date: Feb. 28, 2025

Related U.S. Application Data
(60) Provisional application No. 63/409,361, filed on Sep. 23, 2022.

(51) Int. Cl. H04W 72/0446; H04L 1/1829; H04W 72/25

(52) U.S. Cl. CPC H04W 72/0446; H04L 1/1854; H04W 72/25

(57) ABSTRACT

Techniques discussed herein can facilitate multi-slot sidelink transmissions in the unlicensed spectrum. One example aspect is a baseband processor of a user equipment (UE), comprising a memory and one or more processors configured to, when executing instructions stored in the memory, cause the UE to determine a resource block (RB) set configuration for a multi-slot sidelink transmission with n slots. The one or more processors are further configured to determine a sidelink control information (SCI) configuration, based on the RB set configuration and generate SCI for the multi-slot sidelink transmission based on the SCI configuration. The SCI configuration includes a first stage SCI in a physical sidelink control channel (PSCCH) and a second stage SCI in a physical sidelink shared channel (PSSCH). Subsequently, the one or more processors are further configured to transmit the multi-slot sidelink transmission over the n slots where the multi-slot sidelink transmission includes the PSCCH and the PSSCH.

### FIELD

The present disclosure relates to wireless communication networks and mobile device capabilities.

### BACKGROUND

Mobile communication in the next generation wireless communication system, 5G, new radio (NR), sixth generation technology, and so on will provide ubiquitous connectivity and access to information, as well as the ability to share data, around the globe. Next generation wireless communication systems provide service-based framework that will target to meet versatile, and sometimes conflicting, performance criteria. Such technology may include solutions for enabling user equipment (UE) to communicate with one another directly.

### BRIEF DESCRIPTION OF THE DRAWINGS

FIG. 1 is an example diagram of a wireless network where wireless communication devices configure and facilitate sidelink (SL) unlicensed band communications.

FIGS. 2-4 are resource diagrams illustrating example multi-slot SL unlicensed spectrum (SL-U) transmissions, in accordance with various aspects disclosed.

FIGS. 5-7 are resource diagrams illustrating example multi-slot SL-U transmissions with gaps between the multiple slots, in accordance with various aspects disclosed.

FIGS. 8-9 are resource diagrams illustrating cyclic prefixes adjacent to gaps of multiple slots in multi-slot SL-U transmissions in accordance with various aspects disclosed.

FIGS. 10-11 are flow diagrams illustrating example methods by which a UE can transmit or receive multi-slot SL transmission in accordance with various aspects disclosed.

FIG. 12 illustrates an example of an infrastructure equipment, in accordance with various aspects disclosed.

FIG. 13 illustrates an example of a UE or base station (BS) platform, in accordance with various aspects disclosed.

### DETAILED DESCRIPTION

The present disclosure relates to sidelink (SL) transmissions over multiple slots in the unlicensed spectrum. Techniques discussed herein make use of multiple slots to transmit physical sidelink control channel (PSCCH) and physical sidelink shared channel (PSSCH) messages to achieve faster communications with higher throughput in the unlicensed spectrum between multiple user equipments (UEs).

Wireless networks may include UEs capable of communicating with base stations (BS), wireless routers, satellites, other network nodes, and other UEs. UEs may utilize one or more types of communication technologies to communicate directly with one another including sidelink (SL) communications. SL communications, as described herein, may include a scenario in which a UE operates to discover, establish a connection, and communicate, with one or more other UEs directly. As such, UEs can communicate directly with one another without communicating through an intermediary such as a core network (CN) or BS.

Wireless networks can make use of an unlicensed spectrum for certain types of wireless activities where the unlicensed spectrum may correspond to one or more frequency bands that are not restricted for said wireless activities. SL communications using the unlicensed spectrum may be referred to as SL-U communications. Before a UE conducts a SL-U transmission, the UE may conduct a listen before talk (LBT) procedure as part of a clear channel assessment (CCA) to ensure the unlicensed spectrum is clear before sending the SL transmission.

Multi-slot support for physical uplink shared channel (PUSCH) transmissions are enabled for enhanced license assisted access (LAA) where uplink (UL) signaling can be configured over multiple slots in the unlicensed spectrum. Presently, SL-U communications do not support multi-slot SL transmissions. Multi-slot transmissions can provide increased throughput in the unlicensed band where a transmitting UE and a receiving UE are configured to communicate over multiple slots. Absent multi-slot SL transmissions in the unlicensed band, the transmitting UE and the receiving UE may perform a CCA procedure before and after multiple slots where an SL transmissions occurs. As such, considerable resources may be spent by the transmitting UE and the receiving UE to determine communication channels are clear when data is communicated over more than one slot. As such, enhancements to SL-U transmissions over multiple slots can enable faster and higher throughput communications.

Various aspects of the present disclosure are directed towards multi-slot SL-U transmissions. Mechanisms by which a SL-U transmission is structured over multiple slots are presented herein. For example, arrangement of symbol types and resource block (RB) set configurations are presented, where automatic gain control (AGC) symbols, gap symbols, PSCCH symbols, PSSCH symbols, and PSFCH symbols are configured amongst the multiple slots according to desired performance criteria. A first stage SCI and a second stage SCI are configured to include multi-slot SL-U transmission information that indicates resource allocations of payload data across the multiple slots for the transmitting UE and the receiving UE. Mechanisms for multi-slot SL-U transmissions with full bandwidth (BW) RB set utilization and partial BW RB set utilization are presented herein.

As such, aspects presented herein provide throughput enhancements for SL transmissions over multiple slots according to a transmission structure and multi-slot transmission configuration data in the unlicensed spectrum.

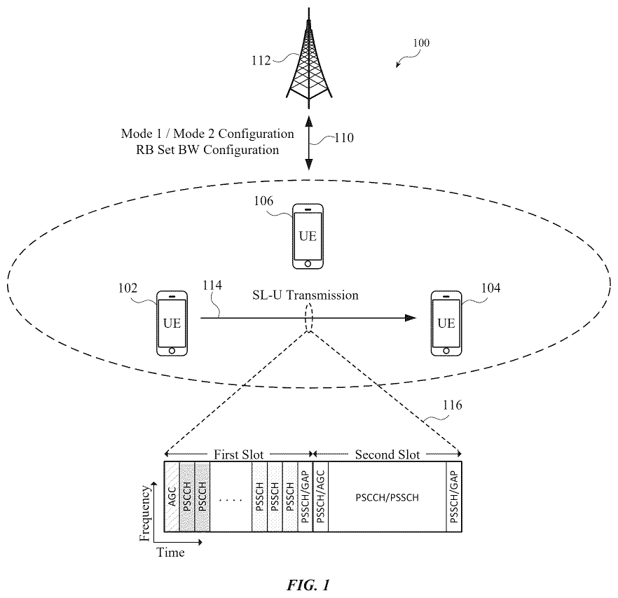

FIG. 1 illustrates an example diagram 100 of a wireless network where wireless communication devices (e.g., UEs, base stations (BSs), or generic devices) configure and facilitate SL-U communications. Each UE in the network includes baseband circuitry that includes one or more processors configured to perform various types of sidelink communication. For the purposes of this description, when a “UE” or “device” is described as performing some function, it can be understood that it is the processor(s) in the baseband circuitry, in conjunction with memory and/or transceivers(s), in some instances, that performs the function. An example wireless communication device, including baseband circuitry, is illustrated in more detail in FIG. 13.

SL communication may be performed according to one of two modes. For example, a Mode 1 or a Mode 2 resource allocation (RA) can be communicated between the BS 112 and the TX UE 102 over an interface 110 (also referred to as a connection). Mode 1 SL resource selection may include a dynamic grant (DG) and configured grant (CG) of SL resources managed by a BS 112 or other network device. A DG may involve a grant based on a grant request from a transmit (TX) UE (e.g., TX UE 102). A CG may involve a resource grant without a grant request and may be based on a type of service being provided (e.g., services that have strict timing or latency requirements). In a mode 1 SL resource selection scenario, the network dynamically allocates SL resources to UEs for SL communications. Further, mode 1 SL resource selection may include a type 1 CG or a type 2 CG.

A type 1 CG may include the BS 112 using radio resource control (RRC) signaling to indicate one or more wireless carriers or channels, a periodicity of allocated resources, an offset, start, and length of resources (e.g., symbols), a number of repetitions, a transmission power level, etc. A type 2 CG may include the BS 112 providing a more limited amount of CG information via RRC (e.g., a periodicity and number of repetitions) and providing additional SL CG information via downlink (DL) control information (DCI). The CG may include DCI with a SL radio network temporary identifier (SL-RNTI), a SL configured scheduling (CS) RNTI (SL-CS-RNTI), etc. By contrast to the network-managed SL resource selection of mode 1, mode 2 SL resource selection may include resource selection largely performed by the TX UE 102. For example, in mode 2 SL resource selection, the BS 112 may provide the TX UE 102 with a pool of potential SL resources, but the UE may perform the sensing (e.g., availability detection), selection, and reservation of the SL resources.

Furthermore, the BS 112 can configure a resource allocation of RB sets for SL communications between the TX UE 102 and a receive (RX) UE 104. For example, the BS 112 can configure a full bandwidth (BW) RB set where the TX UE 102 is configured to generate SL transmissions utilizing all of the available BW of the RB. As such, SL transmissions are configured for an integer number of a RB sets associated with a LBT BW for SL transmissions (e.g., 20 MHz, 40 MHz, 80 MHz, etc.). In other examples, the BS 112 can configure a partial BW set where the TX UE 102 is configured to generate SL transmissions utilizing part of the available BW of the RB.

For example, UEs configured for SL-U may be configured with frequency division multiplexing (FDM) within a RB set, where the TX UE 102 generates SL transmissions in less than the available BW of the RB. In other examples, when the BS 112 configures a partial BW set, the TX UE 102 can determine to disable multi-slot SL transmissions. The BS 112 can disable multi-slot SL transmissions through radio resource control (RRC) signaling. In some situations, partial BW RB set configurations are suited for smaller packet sizes and multi-slot SL transmissions may require a high cost to resource utilization, as such, the BS 112 or the TX UE 102 may determine to disable multi-slot SL transmissions.

The TX UE 102 can configure multiple slot SL transmissions in the unlicensed spectrum according to a slot configuration 116. Slot configuration 116 shows an example with a first slot and a second slot for simplicity in explanation. It is appreciated that the slot configuration 116 can include more than two slots as discussed further herein. To facilitate SL transmissions over multiple slots, the TX UE 102 configures a suitable transmission structure for symbols and multi-slot configuration information for the RX UE 104. The TX UE 102 sends the SL transmission over multiple slots to the RX UE 104 according to a SL interface 114 (also referred to as a connection).

The TX UE 102 generates a first symbol of the first slot with an AGC symbol. The AGC symbol can be a copy of a second symbol of the first slot (e.g., PSCCH symbol). When the RX UE 104 receives the AGC symbol, the RX UE 104 determines received signal strength of the AGC symbol over the frequency spectrum of the RB set. As such, the RX UE 104 can use the AGC symbol to regulate the received signal strength at a radio frequency (RF) input of the RX UE 104 to achieve a desired signal to noise ratio (SNR) for proper decoding of the SL transmissions.

After the AGC symbol, the TX UE 102 generates a sidelink control information (SCI) for symbols of the first slot. The SCI can include a first stage SCI and a second stage SCI. The first stage SCI is carried on a PSCCH and comprises information to enable sensing operations on a SL channel, as well as resource allocation information. The second stage SCI is carried on a PSSCH, and the PSSCH further carries a SL shared transport channel. The second stage SCI carries information to enable identification and decoding of the SL channel, as well as control for Hybrid Automatic Repeat Request (HARQ) procedures, and triggering for channel state information (CSI) feedback, or related information. The SL shared channel carries a transport block (TB) of data for transmission over the SL channel. The SCI includes information for the correct reception of the TB over multiple slots. Thus, various aspects describe the SCI enabling the RX UE 104 to receive and decode the SL transmission in the unlicensed spectrum over multiple slots.

For example, one or more PSCCH symbols in the first slot comprising the first stage SCI can indicate to the RX UE 104 frequency and time resources for subsequent PSSCH reception that includes the second stage SCI. In some aspects, the first stage SCI includes resource information of the one or more PSSCH for multiple slot and time domain slot index information for the multiple slots. The time domain slot index identifies the slots allocated for multi-slot SL transmissions. Furthermore, the first stage SCI can include a channel occupancy time (COT) for CCA associated with the first slot or multiple slots depending on the configuration of RB sets (e.g., multi-slot transmissions for full BW RB sets or partial BW RB sets, and discussed further herein). Subsequently, one or more PSSCH symbols that include the second stage SCI are configured after the AGC symbol and after the one or more PSCCH symbols. The RX UE 104 receives the one or more PSCCH symbols according to the resource information from the first stage SCI.

The second stage SCI can include a HARQ ID, a redundancy version (RV) of a HARQ process for the HARQ ID, and new data indicator (NDI). The HARQ ID identifies a HARQ process, the RV identifies retransmitted HARQ packets, and the NDI indicates whether a TB includes new data so that the RX UE 104 can reset an associated receive buffer to store the new data. In some examples, for each HARQ process, the HARQ ID can be 4 bits, the RV can be 1 to 2 bits, and the NDI can be 1 bit. The second stage SCI can be transmitted in the first slot and include HARQ ID, RV, and NDI information for the multiple slots of the SL transmission. In other aspects, the second stage SCI can be transmitted in each slot of the multiple slots and identify one or more of the HARQ ID, RV, or NDI of the slot comprising the second stage SCI.

A last symbol of the first slot can include either a PSSCH or a gap depending on if the RB set configuration is for full BW or partial BW SL transmissions. For example, when the RB set is configured for full BW SL transmissions, the last symbol of the first slot can be the PSSCH, and the TX UE 102 configures continuous transmissions of PSCCH or PSSCH over the multiple slots. When the TX UE 102 configures continuous transmissions, other UEs may be blocked from SL-U communications that share the same resource configuration as the TX UE 102. For instance, a SL UE 106 may perform CCA on the same resources that TX UE 102 is continuously transmitting, and the SL UE 106 may determine that the associated communication channel is occupied. As a result, the SL UE 106 may be blocked from SL-U communications until the TX UE 102 finishes multi-slot SL transmissions.

In another example, to facilitate SL communication in unlicensed spectrum, a multi-slot SL transmission may include gaps for CCA. The last symbol of the first slot can be the gap, and the TX UE 102 configures discontinuous transmissions of PSCCH or PSSCH over the multiple slots. In one example, either the TX UE 102 and other UEs can be configured for the same RB set, and can be configured with FDM where less than the full BW is utilized (e.g., for small packet transmissions). As such, the TX UE 102 can configure the gap in the last symbol of the first slot so that other UEs can perform CCA and have an opportunity to communicate. As such, the TX UE 102 and the RX UE 104 will perform CCA during the gap to ensure the SL-U channel is clear before proceeding with subsequent SL transmissions over the multiple slots. Furthermore, the TX UE 102 can configure gaps in the last symbol of the first slot when configured with full BW RB sets.

The second slot (or subsequent slots after the first slot) can be configured with AGC, PSCCH, PSSCH, or gaps depending on the RB set configuration and performance criteria. For example, the second slot can be configured for minimal impact of standards adoption and pre-configuration of UEs where the second slot is configured the same as the first slot. Or the second slot can be configured for increased data throughput by comprising only PSSCH. Or the second slot can be configured with AGC symbols, PSCCH symbols, PSSCH symbols, or gap symbols to increase communication reliability according to the RB set configuration.

Additional aspects of the transmission structure for multi-slot SL-U transmissions are discussed further herein.

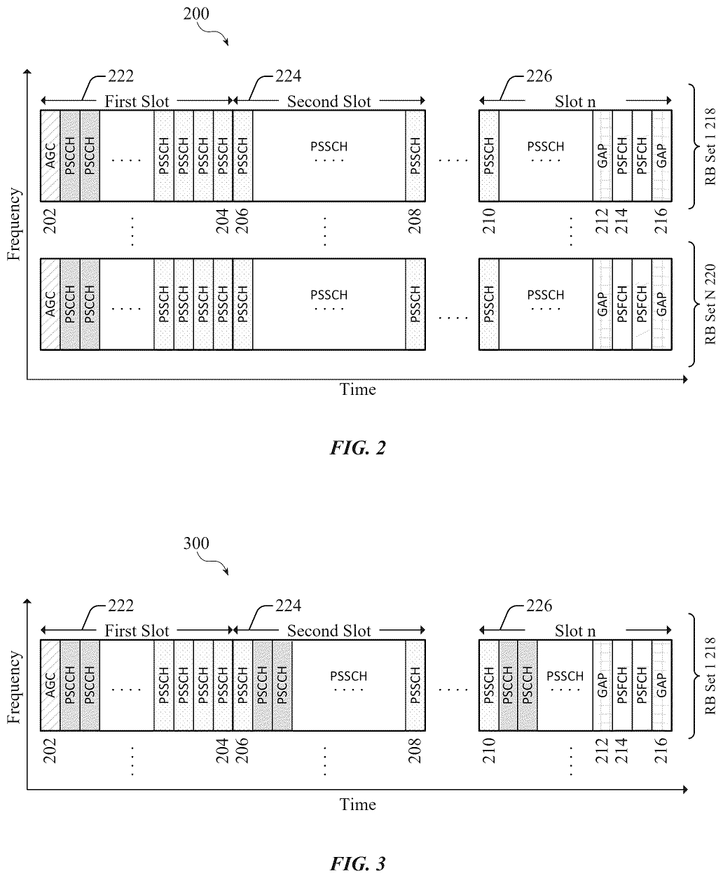

FIG. 2 is a resource diagram 200 illustrating an example multi-slot SL-U transmission for full BW RB sets with an AGC symbol and first stage SCI configured in a first slot. The resource diagram 200 corresponds to the slot configuration 116 of FIG. 1, and depicts multiple slots transmitted by TX UE 102 and received by RX UE 104. Furthermore, resource diagram 200 is directed to mode 1 RA CG or mode 2 RA configurations.

UEs may contend for access to the unlicensed frequency bands by performing CCA and LBT procedures during a contention window (CW) that can vary according to sensed channel conditions and other factors. When TX UE 102 determines to transmit in the unlicensed spectrum, the TX UE 102 first performs a channel sensing operation before initiating the SL transmission. After the TX UE 102 senses a clear channel (e.g., by sensing less than a threshold amount of energy in the channel during the CW or detecting a particular sequence), the TX UE 102 acquires a SL channel occupancy time (COT) during which the device can transmit its data payload and receive feedback signals from RX UE 104 and/or the BS 112. The maximum SL COT has a predetermined length, which is set by a channel access priority class associated with a particular transmission.

After the TX UE 102 determines that the unlicensed spectrum is clear, SL transmissions over multiple slots can be configured according to the resource diagram 200 and transmitted to the RX UE 104 according to the SL interface 114. As such, the TX UE 102 can determine a RB set configuration for a multi-slot SL transmission. The RB set configuration may correspond to either a full BW or a partial BW of the RB set for n slots of the multi-slot SL transmission, and in the example depicted in FIG. 2, reflects the full BW configuration. The RB set can be determined from configuration signaling with BS 112.

The resource diagram 200 shows multiple RB sets where the TX UE 102 can configure one or more RB sets, for example, RB set 1 218 through RB set N 220. The TX UE 102 can determine an SCI configuration based on the RB set configuration. Each of the one or more RB sets comprises multiple slots for SL transmissions. In the resource diagram 200, the multiple slots include a first slot 222 followed by a second slot 224 through a slot n 226, which is a last slot of the multi-slot SL transmission. As such, the multiple slots can be referred to as n slots. It is understood that while the resource diagram shows at least three slots, the n slots can be any number including two or more slots.

The TX UE 102 configures a first symbol 202 of the first slot 222 comprising an AGC symbol used by the RX UE 104 to regulate the received signal strength of the multiple slots. After the first symbol, the first slot 222 comprises PSCCH. The PSCCH in the first slot 222 can include the first stage SCI. After the PSCCH in the first slot 222, the first slot 222 can further include symbols with PSSCH comprising the second stage SCI. As such, the PSCCH and PSSCH are generated for at least the first slot 222 of the n slots.

The TX UE 102 configures a last symbol of the first slot 222 comprising a PSSCH symbol. A first symbol of the second slot 224 is configured with PSSCH and all of the symbols of the second slot 224, including a last symbol of the second slot 224 are configured with PSSCH. As such, the multi-slot SL transmission can be configured continuously over one or more of the n slots and the TX UE 102 can transmit the multi-slot sidelink transmission over the n slots where the multi-slot sidelink transmission includes the PSCCH and the PSSCH. In particular, the multi-slot SL transmission can be configured continuously over the n slots without a gap between the n slots.

The first symbol 210 of slot n 226 is configured with PSSCH, and the final symbols of slot n 226 include a gap (e.g., symbol 212), PSFCH (e.g., symbol 212), followed by another gap (e.g., symbol 216). The final symbols of slot n provide an opportunity for the TX UE 102 to request acknowledgement from the RX UE 104 that the multi-slot SL transmission was received. In response, the RX UE 104 transmits the acknowledgement or negative acknowledgement ACK/NACK in the PSFCH, for example, at symbol 214. As such, the gap configured before the PSFCH symbol allows for the TX UE 102 to perform transmit to receive switching, and RX UE 104 to perform receive to transmit switching and to perform CCA. The RX UE 104 performs CCA to determine the channel is clear before the RX UE 104 sends the ACK/NACK.

As the multi-slot SL transmission is transmitted continuously by the TX UE 102, the RX UE 104 can rely on the received signal strength of the AGC symbol in the first symbol 202 of the first slot 222 when receiving the n slots. In this aspect, the AGC symbol in the first symbol 202 of the first slot 222 is the only AGC symbol of the n slots, and is the only AGC symbol between the first slot and a physical sidelink feedback channel (PSFCH) comprised in final slot or slot n 226 of the multi-slot sidelink transmission.

The SCI can carry the multi-slot SL transmission information discussed in accordance with FIG. 1, including the COT information, time domain slot index information of the n slot, HARQ ID, RV, and NDI. In some aspects, the second stage SCI is transmitted in one or more PSSCH symbols of the first slot 222 and includes HARQ IDs for all of the n slots. In other aspects, the second stage SCI is transmitted per slot of the n slots, for example, in symbols with PSSCH, and includes HARQ information on a per slot basis. In some examples, transmitting the second stage SCI per slot of the n slots with unique HARQ information can provide reliability enhancements because if the first slot 222 is not received by the RX UE 104, then the HARQ information can still be received in subsequent slots. However, configuring the second stage SCI per slot can decrease increased throughput relative to configuring the second stage SCI for only the first slot 222 at the benefit of increased reliability.

The example depicted in FIG. 2 shows PSCCH, the first stage SCI, and AGC only generated for the first slot 222 and continuous multi-slot SL PSSCH transmission over the n slots. As such, symbols of PSSCH over the n slots can maximize TB with payload data and the resource configuration of FIG. 2 can maximize data throughput for SL-U transmissions.

FIG. 3 is a resource diagram 300 illustrating example multi-slot SL-U transmission for full BW RB sets with a first stage SCI configured in multiple slots. The resource diagram 300 corresponds to the slot configuration 116 of FIG. 1, and depicts multiple slots transmitted by TX UE 102 and received by RX UE 104. Furthermore, resource diagram 300 is directed to mode 1 RA CG or mode 2 RA configurations.

Resource diagram 300 shows features introduced in accordance with resource diagram 200 with alternative aspects according to PSCCH and the first stage SCI configured in multiple slots. The first stage SCI configured in each of the n slots can provide multi-slot information on a per slot basis (e.g., COT sharing information), and additionally or alternatively provide resource information for receiving the second stage SCI in each of the n slots. For brevity, FIG. 3, and subsequent figures, only shows RB Set 1 218 with additional RB sets denoted by dotted lines, for example, additional RB sets through RB set N 220.

Resource diagram 300 shows symbols of PSCCH configured in each of the n slots. For example, PSCCH is configured after the first symbol 206 of the second slot 224 and before the last symbol 208 of the second slot 224. It is understood that the resource diagram 300 shows a particular arrangement of PSCCH, but other arrangements of PSCCH in each of the n slots are possible, for example one or more PSCCH can be configured in alternative slot positions than those depicted in FIG. 3. In some examples, the PSCCH symbols are can be configured in a first symbol of the n slots, and in some examples, the PSCCH symbols are configured before a last symbol of each of the n slots.

The PSCCH configured in each of the n slots can include the first stage SCI. As such, the first stage SCI is generated for the first slot 222 and n-1 slots after the first slot. As described in accordance with FIG. 2, the PSSCH configured for each of the n slots can include the second stage SCI. In some aspects, the first stage SCI configured for each of the n slots can include information for the RX UE 104 to receive the second stage SCI configured for each of the n slots. The first stage SCI comprised in the PSCCH symbols can include COT information for COT sharing, which can be different on a per slot basis.

The COT information can indicate that COT sharing is enabled for SL transmissions. For example, if the initiating TX UE 102 only uses 2 milliseconds (ms) of an acquired COT and a total COT duration is 8 ms is configured, then the RX UE 104 could potentially utilize a remaining 6 ms of the shared COT based on the COT indications provided by the TX UE 102. As such, the COT information in the first stage SCI can include an indication of the remaining COT for COT resource sharing and denotes for both the TX UE 102 and the RX UE 104 how much time remains for the multi-slot SL transmission. As the time designated for the multi-slot SL transmission decreases after each of the n slots are transmitted, the first stage SCI includes COT information that is different for at least two of the n slots.

The resource allocation of resource diagram 300 can realize increased reliability by including the first SCI and the second SCI in each slot of the n slots albeit with a less efficient use of resources compared to resource diagram 200.

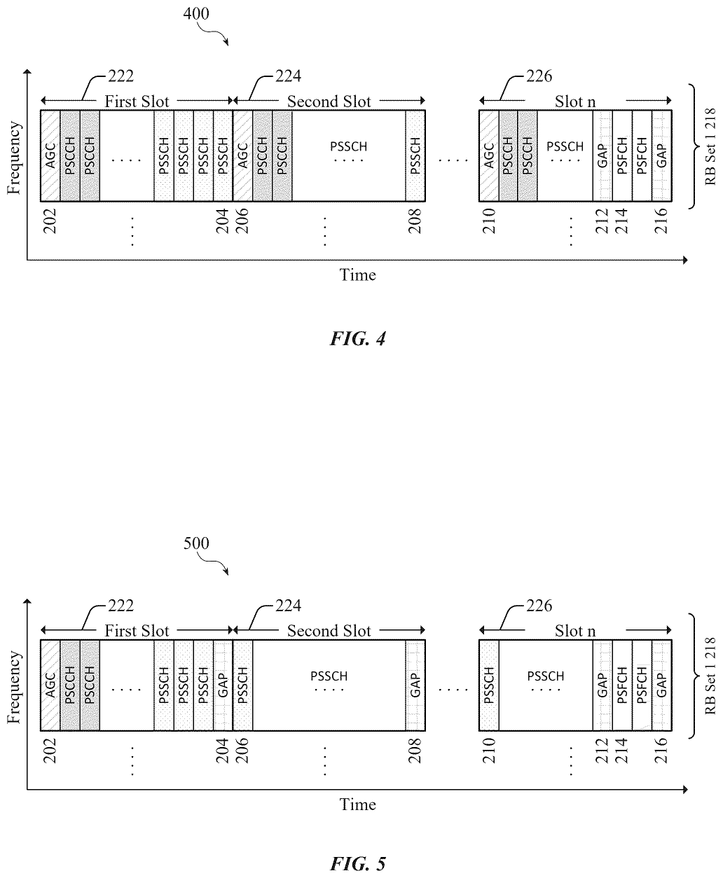

FIG. 4 is a resource diagram 400 illustrating an example multi-slot SL-U transmission for full BW RB sets with an AGC symbol configured in multiple slots. The resource diagram 400 corresponds to the slot configuration 116 of FIG. 1, and depicts multiple slots transmitted by TX UE 102 and received by RX UE 104. Furthermore, resource diagram 400 is directed to mode 1 RA CG or mode 2 RA configurations.

Resource diagram 400 shows features introduced in accordance with resource diagram 300 with alternative aspects according to the AGC configured in multiple slots. The resource allocation of FIG. 4 provides uniform slot configurations for all but the last slot of the n slots therefore providing easy implementation of slot configurations and compatibility with legacy slot configurations.

Resource diagram 400 shows symbols of AGC configured for a first symbol of each of the n slots. For example, AGC is configured for first symbol 202 of the first slot 222, the first symbol 206 of the second slot 224, and the first symbol 210 of the slot n 226. The resource allocation of resource diagram 400 provides the same slot configuration for all of the slots except for the last slot of the n slots (e.g., slot n 226).

As such, a same slot configuration can be configured for most of the n slots and provide a straight forward and simple slot configuration for multi-slot SL transmission.

Furthermore, the resource allocation of resource diagram 400 can result in a minimal impact to standards adoption and can provide compatibility with legacy slot configuration. However, the resource allocation of resource diagram 400 can have less throughput and less efficient use of resources as compared to resource allocations depicted in resource diagram 200 and resource diagram 300.

FIG. 5 is a resource diagram 500 illustrating an example multi-slot SL-U transmission for partial BW RB sets with a gap configured in multiple slots. The resource diagram 500 corresponds to the slot configuration 116 of FIG. 1, and depicts multiple slots transmitted by TX UE 102 and received by RX UE 104. Furthermore, resource diagram 500 is directed to mode 1 RA CG or mode 2 RA configurations. Resource diagram 500 shows features introduced in accordance with resource diagram 200 with alternative aspects according to a gap configured at a last symbol of each of the n slots. The resource allocation of resource diagram 500 can maximize throughput for multi-slot SL transmissions with partial BW RB set configurations.

Resource diagram 500 shows gap symbols at a last symbol of each of the n slots, the first stage SCI configured for the first slot 222 of the n slots, and the AGC symbol is only configured in the first symbol 202 of the first slot 222. When the TX UE 102 is configured for a partial BW of the RB set, the gap symbols are configured so that other UEs can perform CCA and have an opportunity to communicate as discussed in accordance with FIG. 1. As depicted in FIG. 5, the gap is configured for the last symbol 204 of the first slot 222 and the last symbol 208 of the second slot 224. During the gap (e.g., gap at last symbol 204), at least the TX UE 102 performs CCA and if the unlicensed spectrum is clear, then the TX UE 102 can transmit the subsequent slot (e.g., second slot 224).

CCA can include LBT categories or types that describe channel sensing operations to determine if the channel is clear or busy. The CCA type can be indicated by the first stage SCI. LBT types include a type 2, also referred to as a one-shot LBT procedure, or type 1. The type 2 LBT is performed without a back-off or a random back-off. The type 2 LBT can include channel sensing for a duration, and if the channel is idle or clear during the duration, the channel can be accessed. If the channel is not idle or clear during the duration, then the channel can be sensed again according to a sensing interval for the period of time.

Type 2 channel access procedures can further be classified into various types, for example, type 2A, type 2B, and type 2C. The type 2A LBT can be applicable when a transmitting UE (e.g., TX UE 102) transmits in the unlicensed band following transmission by another UE (e.g., SL UE 106) where the sensed channel is idle for at least a gap greater than or equal to 25 microseconds (μs) of a shared COT. The type 2A LBT can be application when a transmitting UE (e.g., Tx UE 102) transmits in the unlicensed band after acquiring a COT, subsequently stops transmission for a short period of time (for example, due to an empty buffer, or due to a resource pool configuration with a slot that is not configured for SL transmission, or due to a sidelink synchronization signal block (S-SSB) slot gap, or due to a gap created within the multi-slot SL transmission etc. ), and resume transmission in the COT within the maximum COT (mCOT) limit. The type 2A LBT can also be used before S-SSB transmission. In type 2A sensing, the 25 μs include a 16 μs slot followed by a 9 μs slot. For type 2A LBT, the UE (e.g., TX UE 102) should sense for at least 4 μs within the 16 μs slot, and at least 4 μs within the 9 μs slot. The type 2A LBT is successful determines both the 16 μs slot followed by the 9 μs slot are clear according to the associated sensing time (e.g., 4 μs), then the energy detection threshold (EDT) for the type 2A LBT is satisfied.

The type 2B LBT can be applicable when a transmitting UE (e.g., TX UE 102) transmits in the unlicensed band following transmission by another UE (e.g., SL UE 106) where the sensed channel is idle for at least a gap of 16 microseconds of a shared COT. The type 2B LBT can be applicable when a transmitting UE (e.g., TX UE 102) transmits in the unlicensed band after acquiring a COT, subsequently stops transmission for a 16 μs gap, and resume transmission within the mCOT. In type 2B LBT sensing, the UE should sense at least 4 μs within the 16 μs gap. The type 2B LBT is successful if the 4 μs of the 16 μs gap is clear, thus the EDT for the type 2B LBT is satisfied.

The type 2C LBT can be applicable when a transmitting UE (e.g., TX UE 102) transmits in the unlicensed band following transmission by another UE (e.g., SL UE 106) where the sensed channel is idle for at least a gap less than or equal to 16 microseconds of a shared COT and the transmitting UE transmits in the unlicensed band for a short duration (e.g., short duration of at most 584 microseconds). The type 2C LBT can be applicable when a transmitting UE (e.g., TX UE 102) transmits in the unlicensed band after acquiring a COT, subsequently stops transmission for a 16μs gap, and resume transmission within the mCOT. The UE does not need to sense the channel for type 2C LBT.

The type 1 LBT is a LBT procedure with a random back-off according to a CW of a variable size. As such, the CW has a fixed length or size (CWS) that can vary according to at least one sensed channel conditions or other factors. Implementation of CAT-4 LBT involves the UE implementing a back-off from the channel (where the UE does not transmit in the channel) for a period of time according to a random number drawn from a contention window. The contention window can be variable in size based on channel characteristics. As such, the UE senses the channel during the back-off to determine if the channel is clear or busy. If the channel is busy, the UE pauses a type 1 LBT counter and continues sensing the channel. If the associated sensing slot is clear, the UE resumes count down of the type 1 LBT counter in the contention window. The random back-off is adopted to avoid collisions when interference occurs during a previous transmission in the unlicensed spectrum. In some examples, a back-off mechanism can include increasing the CWS to a next value when interference is detected and reducing or resetting the CWS when interference is not detected. In some examples, the back-off mechanism is an exponential back-off after the UE determines the channel is not clear. When the UE the type 1 LBT counter is decremented to 0, the type 1 LBT procedure completes successfully.

The TX UE 102 can perform the type 1 LBT prior to determining to transmit the multi-slot SL transmission. The TX UE 102 can perform the type 2 LBT (e.g., type 2A, type 2B, or type 2C) depending the gap duration and the CCA configured or indicated by the first stage SCI. Further details regarding the LBT type performed during the gap is discussed in accordance with FIGS. 7-9.

Resource diagram 500 provides a slot configuration optimized for throughput as the first stage SCI is only transmitted in the first slot 222. In some aspects, the second stage SCI can be transmitted in the first slot 222, or in all of the n slots as discussed in accordance with FIG. 2.

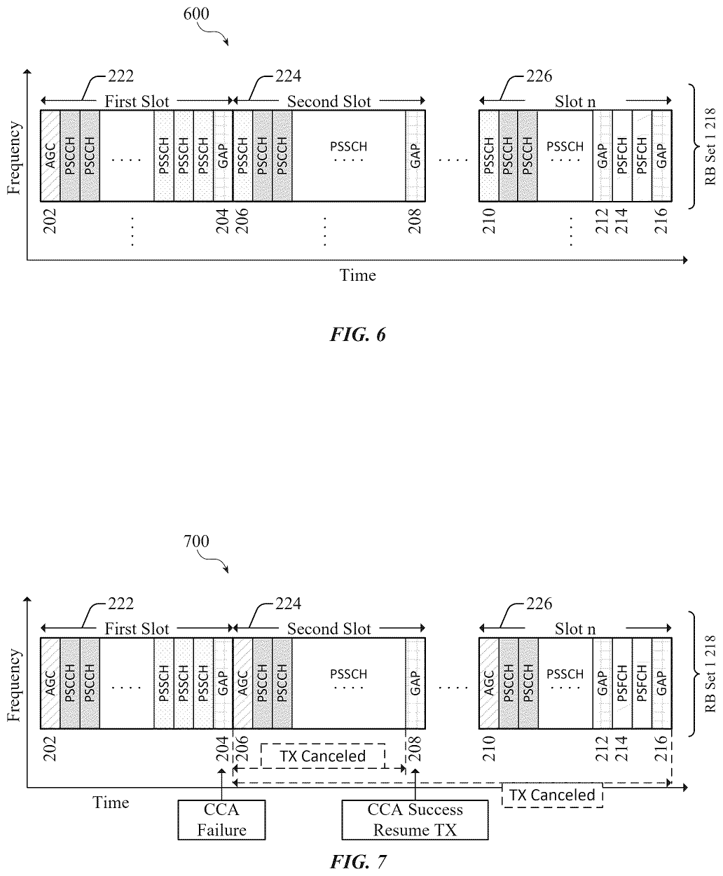

FIG. 6 is a resource diagram 600 illustrating an example multi-slot SL-U transmission for partial BW RB sets with a gap and first stage SCI configured in multiple slots. The resource diagram 600 corresponds to the slot configuration 116 of FIG. 1, and depicts multiple slots transmitted by TX UE 102 and received by RX UE 104. Furthermore, resource diagram 600 is directed to mode 1 RA CG or mode 2 RA configurations. Resource diagram 600 shows features introduced in accordance with resource diagram 300 with alternative aspects according to a gap configured at a last symbol of each of the n slots, as presented in resource diagram 500. The first stage SCI configured in each of the n slots can provide multi-slot information on a per slot basis (e.g., COT sharing information), and additionally or alternatively provide resource information for receiving the second stage SCI in each of the n slots.

Resource diagram 600 shows gap symbols in a last symbol of each of the n slots, the first stage SCI configured each of the n slots, and the AGC symbol only configured in the first symbol 202 of the first slot 222. The first stage SCI is carried in PSCCH symbols of the n slots. As describe in accordance with FIG. 2, the PSSCH configured for each of the n slots can include the second stage SCI. In some aspects, the first stage SCI configured for each of the n slots can include information for the RX UE 104 to receive the second stage SCI configure for each of the n slots. The first stage SCI comprised in the PSCCH symbols can include COT information for COT sharing, which can be different on a per slot basis.

The resource allocation of resource diagram 600 can realize increased reliability for partial BW RB resource sets by including the first SCI and the second SCI in each slot of the n slots with a less efficient use of resources compared to the resource allocation of resource diagram 600.

FIG. 7 is a resource diagram 700 illustrating an example multi-slot SL-U transmission for partial BW RB sets with AGC symbols configured in multiple slots. The resource diagram 700 corresponds to the slot configuration 116 of FIG. 1, and depicts multiple slots transmitted by TX UE 102 and received by RX UE 104. Furthermore, resource diagram 700 is directed to mode 1 RA CG or mode 2 RA configurations. Resource diagram 700 shows features introduced in accordance with resource diagram 400 with alternative aspects according to a gap configured at a last symbol of each of the n slots, as presented in resource diagrams 500 and 600. In some aspects, SL-U channel conditions can change due to communications that may occur during gaps between slots of the n slots. As such, the AGC configured for the multiple slots can provide the RX UE 104 an opportunity to re-regulate the received signal strength of symbols of the n slots according to a desired SNR for proper decoding of the SL transmissions.

Resource diagram 700 shows symbols of AGC configured for a first symbol of each of the n slots. For example, AGC is configured for first symbol 202 of the first slot 222, the first symbol 206 of the second slot 224, and the first symbol 210 of the slot n 226. The resource allocation of resource diagram 700 provides the same slot configuration for all of the slots except for the last slot of the n slots (e.g., slot n 226).

As such, a same slot configuration can be configured for most of the n slots and provide a straight forward and simple slot configuration for multi-slot SL transmission with gaps for CCA. Relative to other solutions presented herein, resource diagram 700 can have less throughput due to a less efficient use of resources due to transmitting AGC, PSCCH, PSSCH, and gaps in all of the n slots.

Resource diagram 700 additionally shows operations for CCA failure and multi-slot SL transmissions. Two CCA failure options can apply to one or more of FIGS. 5-9. In a first option, the TX UE 102 performs the type 2 LBT (e.g., type 2A, type 2B, or type 2C) at the gap configured at the last symbol (e.g., last symbol 204 or last symbol 208) of a slot (e.g., first slot 222 or second slot 224) of the n slots. When the CCA detects that the SL-U channel is busy, the TX UE 102 determines that CCA failed and cancels transmissions in remaining slots of the n slots (e.g., cancels second slot 224 through slot n 226 transmissions). In this option, the multi-slot SL transmission is effectively aborted.

In a second option, when the CCA detects that the SL-U channel is busy at the last symbol (e.g., last symbol 204 or last symbol 208) of a slot (e.g., first slot 222 or second slot 224) of the n slots, the TX UE 102 determines that CCA failed and cancels transmission of a subsequent slot of the n slots. For example, when the channel is busy during the last symbol 204 of the first slot 222, the multi-slot SL transmission is canceled for the second slot 224. The TX UE 102 performs another CCA, such as a type 2 LBT (e.g., type 2A, type 2B, or type 2C) configured in a last symbol of the subsequent slot of the n slots. For example, when CCA failure is detected in the first slot 222, another CCA is performed at the last symbol 208 of the second slot 224. The TX UE 102 can continue transmitting the multi-slot sidelink transmission in the n slots with additional CCA gaps in the subsequent slots. For example, the TX UE 102 can determine the channel is clear at the last symbol 208 of the second slot 224, and continue multi-slot SL transmissions in the n slots.

The gap configured at the end of each of the slots provides an opportunity for other UEs (e.g., SL UE 106) to transmit. For example, SL UE 106 can perform a type 1 LBT prior to the gap configured at the end of one of the slots of the n slots. The SL UE 106 can freeze the type 1 LBT counter, and wait until the gap before performing a type 2 LBT during the gap. When the SL UE 106 determines the SL-U channel is clear during the type 2 LBT at the gap, the SL UE 106 can start transmitting in the SL-U channel which can trigger the TX UE 102 to perform one of the two CCA failure options.

It is understood that FIG. 7 is an example and the TX UE 102 can detect CCA failure at the end of any of gap configured at the end of any of the n slots, and subsequently follow the cancelation of all or some of the remaining n slots based on the first or second option described herein. The first or second option can be configured by the BS 112 or pre-determined by the TX UE 102. The first option is easier to implement but results in termination of the multi-slot SL transmission. The second option is implemented with more complexity relative to the first option with the benefit of being capable of continuing to transmit the multi-slot SL transmission and potentially higher cost of sensing resources from the TX UE 102.

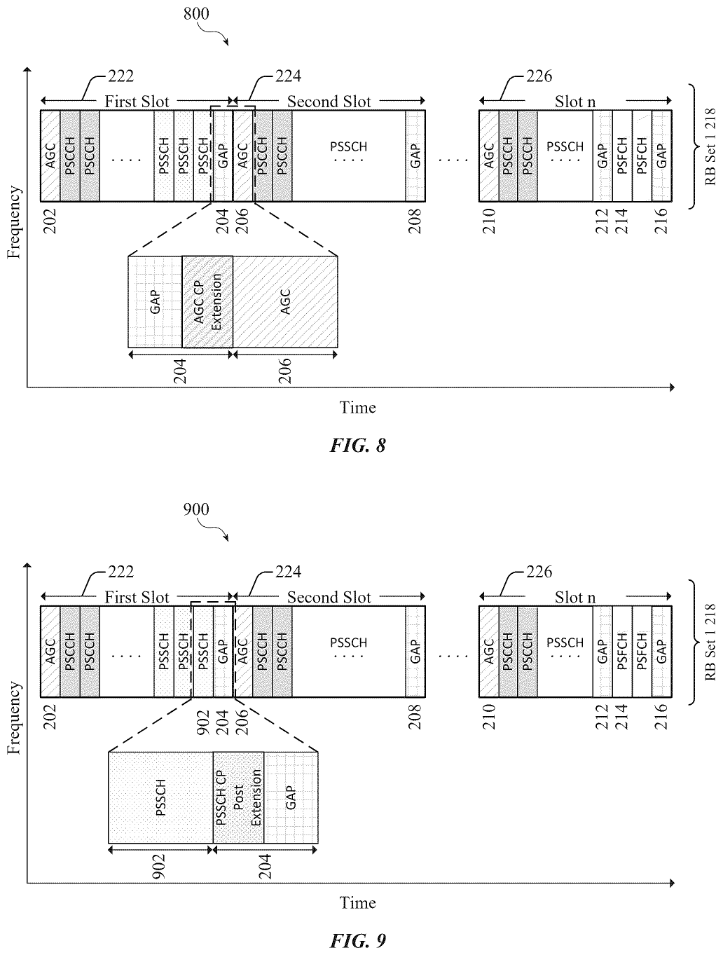

FIGS. 8 and 9 are resource diagrams 800 and 900 illustrating example cyclic prefix (CP) configurations before or after gaps of the n slots. Features related to the CP configurations can apply to FIGS. 5-7. CP configurations can mitigate the chances of other UEs transmitting in the SL-U channel so that the multi-slot SL transmission is not interrupted during the configured gaps. The slot duration can be a based on a numerology. The numerology is a subcarrier spacing type, for example, 15 kHz, 30 kHZ, 60 KHZ, etc., and effects the duration of the slot. In some examples, the gap is configured for the full duration of a last symbol of the n slots. The duration of the last symbol of the n slots may be a longer duration, for example, greater than 25 microseconds. A longer symbol duration where the TX UE 102 is not transmitting can increase the chances that another UE (e.g., SL UE 106) may sense the SL-U channel is clear, and start transmitting which would initiate multi-slot SL transmission slot cancellations as described in accordance with the two CCA failure options of FIG. 7.

To minimize the chances of a busy SL-U channel, the TX UE 102 can configure short gaps, for example, approximately 25 microseconds or less. When the short gap is less than the corresponding symbol, the TX UE 102 can configure a CP in the symbol so that other UEs detect the SL-U channel busy outside of the shorter gap. The CP is configured with a repetition of an associated symbol. The receiving UE can be configured to discard the CP.

The CP can be configured for the first symbol of the slot after the gap. FIG. 8 depicts an AGC CP extension configured for the AGC symbol. The gap is configured for the last symbol 204 of the first slot 222. The AGC CP extension is configured at the end of the last symbol 204 that is not configured for the gap. The AGC CP extension separates the gap configured for the last symbol 204 of the first slot 222 from the first symbol 206 comprising AGC of the second slot 224. Thus the CP extension of a first symbol of the n slots is configured between the gap of a last symbol of the n slots and the first symbol of the n slots. As such, other UEs will determine that the SL-U channel is busy during the time in which the CP extension is transmitted. While this example shows the CP extension relative to an AGC symbol, it is understood that the CP extension can be configured for any symbol type configured in the symbol after the gap.

The CP can be configured for a symbol preceding the gap, and the CP is a post-extension. FIG. 9 depicts a PSSCH CP post extension configured for the PSSCH symbol. The gap is configured for the last symbol 204 of the first slot 222. The PSSCH CP post extension is configured at the beginning of the last symbol 204 that is not configured for the gap. The PSSCH CP post extension separates the second to last symbol 902 of the first slot 222 from the last symbol 204 of the first slot 222. Thus the CP post extension of a second to last symbol of the n slots is configured between the second to last symbol of the n slots and the gap of a last symbol of the n slots, wherein the gap is configured in a last symbol of the n slots. As such, other UEs will determine that the SL-U channel is busy during the time in which the CP post extension is transmitted. While this example shows the CP post extension relative to a PSSCH symbol, it is understood that the CP post extension can be configured for any symbol type configured in the symbol before the gap.

The gap (with or without an adjacent configured CP) can be approximately a 16 microsecond gap or approximately a 25 microsecond gap. When the gap is approximately 25 microseconds, the other UEs (e.g., SL UE 106) and the TX UE 102 can perform the type 2A LBT during the gap. When the gap is approximately 16 microseconds, the other UEs (e.g., SL UE 106) and the TX UE 102 can perform the type 2B LBT or type 2C LBT.

FIGS. 2-9 show resource allocations for full BW RB sets and partial BW RB sets. Alternative resource allocations can apply for the full BW and partial BW RB sets. For example, FIGS. 5-9 can be performed with continuous RB allocations or interlaced RB allocations. Additionally or alternatively, while FIGS. 5-9 are described in the context of partial BW RB sets, the TX UE 102 can configure the resource allocations of FIGS. 5-9 for full BW RB sets to realize resource allocation flexibility and compatibility with legacy systems or simplified standardizations.

Additionally or alternatively, the PSFCH can be configured for one or more slots of the n slots other than the last slot of the n slots (e.g., PSFCH configured for middle slots of the n slots) in FIGS. 2-9. As such, the TX UE 102 can configure feedback from the RX UE 104 at more than one slot of the n slots to determine if the multi-slot SL transmission is being received by the RX UE 104. In some examples, the gap at the end of the last slot of the n slots in FIGS. 5-9 can be configured for CCA before PSFCH configured at the first symbol of a subsequent slot after the gap. When fast switching times are configurable, the last slot of the n slots with the gap can be configured with a 16 microsecond gap or less and a quicker type 2 LBT can be performed by the RX UE 104 before transmitting the ACK/NACK. Alternatively, the PSFCH can be configured in the middle of one or more slots of the n slots with a 16 microsecond or greater gap and a type 2A or type 2B can be performed by the RX UE 104 before transmitting the ACK/NACK. Scheduling the PFSCH at middle slots of the n slots can increase reliability as the TX UE 102 can determine if sets of data are received correctly by the RX UE 104, and if there are failures, the TX UE 102 can re-transmit data in remaining slots of the n slots. However, the gaps associated with the PFSCH can lead to increased CCA failure rates that can initiate one of the two CCA failure options described herein.

Furthermore, FIGS. 2-9 are described in the context of Mode 1 RA with CG or Mode 2 RA. Alternatively, the TX UE 102 can be configured for Mode 1 RA with DG.

The TX UE 102 can be configured for a mode 1 RA based on a downlink control information (DCI) format 3_0 received from the BS 112. The DCI format 3_0 may include frequency resource assignment information, time resource assignment information, CCA type information, time gap information, and CP extension information. The frequency resource assignment information may indicate whether a partial BW or a full BW is allocated to TX UE 102, and whether the assigned frequency resources are interlaced waveform resources or continuous waveform resources. The time resource assignment information may include a LBT type to be performed by the TX UE 102, and whether a CP extension is to be used during the SL communications.

As such, the TX UE 102 can determine, from the DCI format 3_0, the n slots for multi-slot SL transmissions and CCA configurations associated with gap configurations for each of the n slots. Thus CCA can be indicated and performed on a per slot basis and can be performed as described in accordance with FIGS. 1-9. For example, the DCI format 3_0 can indicate n=3 slots with CCA gaps where type 1 LBT is configured before transmission of slot 1 of the 3 slots, and type 2B LBT is performed before transmission of slot 2 and slot 3 of the 3 slots. Alternatively, the DCI format 3_0 can indicate a LBT type for the first slot of the n slots, and no gaps between slots, similar to the resource allocation of FIGS. 2-4. Thus aspects of CCA and gaps are indicated to TX UE 102 by the BS 112 through the DCI format 3_0 when Mode 1 RA with DG is configured.

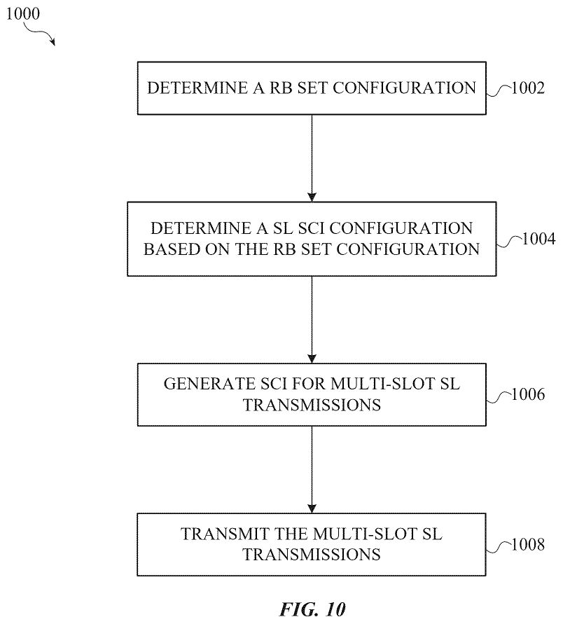

FIG. 10 is a flow diagram outlining an example method 1000 by which a UE performs multi-slot SL transmissions. The example method 1000 may be performed, for example, by the TX UE 102 of FIG. 1.

At 1002, the method includes determining a RB set configuration for a multi-slot SL transmission. The RB set configuration corresponds to a full BW or a partial BW for n slots of the multi-slot SL transmission. Furthermore, the RB set configuration can correspond to a Mode 1 RA CG or DG configuration or a Mode 2 RA configuration.

At 1004, the method includes determining a SCI configuration based on the RB set. The SCI configuration can be based on the full BW or partial BW configuration, an autonomous configuration, or a signaled configuration.

At 1006, the method includes generating SCI for the multi-slot SL transmission. The SCI configuration includes a first stage SCI configured in a PSCCH and a second stage SCI in a PSSCH. The first stage SCI and the second stage SCI can be configured for at least a first slot of the n slots.

At 1008, the method includes transmitting the multi-slot sidelink transmission over the n slots, where the multi-slot sidelink includes the PSCCH and the PSSCH.

Furthermore, the n slots of the multi-slot sidelink transmission can be configured with AGC, gaps, or PSFSH based on the RB set configuration. Additionally or alternatively, the method can include performing CCA in configured gaps of the n slots. FIGS. 1-9 correspond to some aspects of the n slot configuration of act 1008.

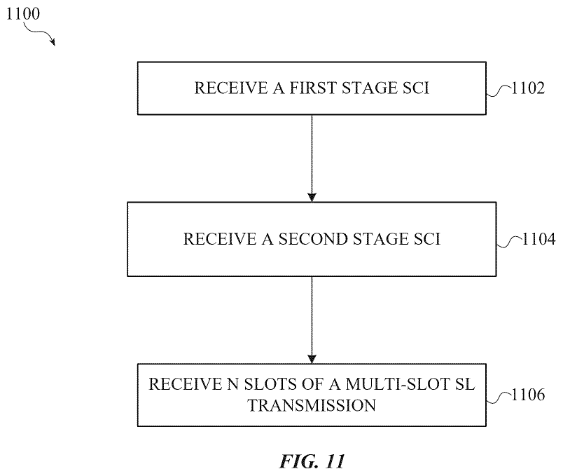

FIG. 11 illustrates a flow diagram of an example method 1100 by which a UE performs multi-slot SL reception. The example method 1100 may be performed, for example, by the RX UE 104 of FIG. 1.

At 1102, the method includes receiving a first stage SCI in a PSCCH. The method can include determining, from the first stage SCI, resource information for reception of a second stage SCI. The method can include determining a RB set configuration, such as a partial BW or a full BW based on the first stage SCI.

At 1104, the method includes receiving a second stage SCI in a PSSCH based on the resource information from the first stage SCI. The first stage SCI and the second stage SCI can include multi-slot information for receiving n slots of a multi-slot SL transmission.

At 1106, the method includes receiving n slots of the multi-slot SL transmission based on the first stage SCI and the second stage SCI. The first stage SCI and the second stage SCI can be received in one or more of the n slots. Furthermore, the n slots of the multi-slot SL transmission can be received with AGC, gaps, or PSFSH based on an RB set configuration. Additionally or alternatively, the method can include performing CCA in configured gaps of the n slots. FIGS. 1-9 correspond to some aspects of the n slot configuration of act 1106.

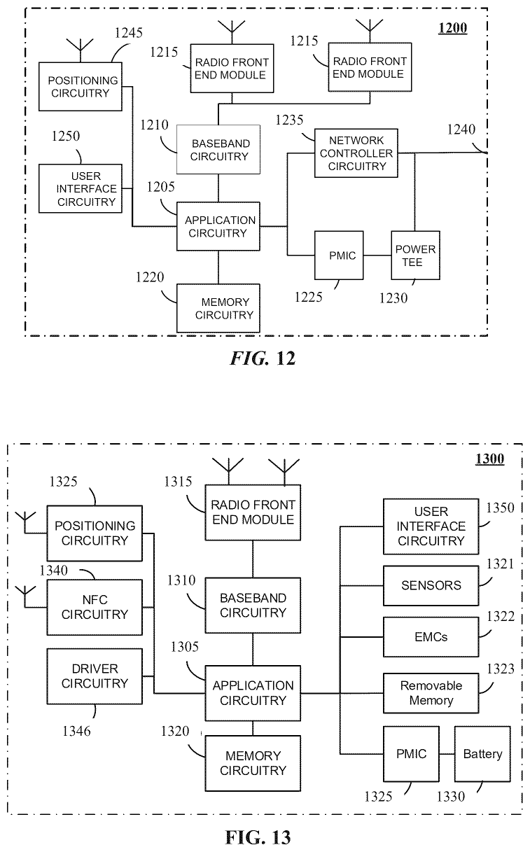

FIG. 12 illustrates an example of a system 1200 (also referred to as infrastructure equipment) in accordance with various aspects. The system 1200 may be implemented as a base station, radio head, radio access network (RAN) node such as the BS 112 of FIG. 1 and/or any other element/component/device discussed herein. In other examples, the system 1200 could be implemented in or by a UE such as TX UE 102, or RX UE 104, or SL UE 106 of FIG. 1.

The system 1200 includes application circuitry 1205, baseband circuitry 1210, one or more radio front end modules (RFEMs) 1215, memory circuitry 1220 (including a memory interface), power management integrated circuitry (PMIC) 1225, power tee circuitry 1230, network controller circuitry 1235, network interface connector 1240, satellite positioning circuitry 1245, and user interface 1250. In some aspects, the device of system 1200 may include additional elements/components/devices such as, for example, memory/storage, display, camera, sensor, or input/output (I/O) interface. In other aspects, the components/devices described below may be included in more than one device. For example, said circuitries may be separately included in more than one device for CRAN, vBBU, or other like implementations.

Application circuitry 1205 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 1205 may be coupled with or may include memory/storage elements/components/devices and may be configured to execute instructions stored in the memory/storage to enable various applications or operating systems to run on the system 1200. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 1205 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more field programmable gate array (FPGAs), one or more PLDs, one or more application-specific integrated circuits (ASICs), one or more microprocessors or controllers, or any suitable combination thereof. In some aspects, the application circuitry 1205 may comprise, or may be, a special-purpose processor/controller to operate according to the various aspects herein. As examples, the processor(s) of application circuitry 1205 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2@ provided by Cavium(TM), Inc.; a MIPS-based design from MIPS Technologies, Inc. such as MIPS Warrior P-class processors; and/or the like. In some aspects, the system 1200 may not utilize application circuitry 1205, and instead may include a special-purpose processor/controller to process IP data received from an EPC or 5GC, for example.

User interface 1250 may include one or more user interfaces designed to enable user interaction with the system 1200 or peripheral component or device interfaces designed to enable peripheral component or device interaction with the system 1200. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component or device interfaces may include, but are not limited to, a nonvolatile memory port, a universal serial bus (USB) port, an audio jack, a power supply interface, etc.

The components or devices shown by FIG. 12 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCle), or any number of other technologies. The bus/IX may be a proprietary bus, for example, used in a SoC based system. Other bus/IX systems may be included, such as an 12C interface, an SPI interface, point to point interfaces, and a power bus, among others.

FIG. 13 illustrates an example of a platform 1300 (or “device 1300”) in accordance with various aspects. In aspects, the platform 1300 may be suitable for use as the TX UE 102, RX UE 104, or SL UE 106 of FIG. 1, and/or any other element/component/device discussed herein such as the BS 112. The platform 1300 may include any combinations of the components or devices shown in the example. The components or devices of platform 1300 may be implemented as integrated circuits (ICs), portions thereof, discrete electronic devices, or other modules, logic, hardware, software, firmware, or a combination thereof adapted in the platform 1300, or as components or devices otherwise incorporated within a chassis of a larger system. The block diagram of FIG. 13 is intended to show a high level view of components or devices of the platform 1300. However, some of the components or devices shown may be omitted, additional components or devices may be present, and different arrangement of the components or devices shown may occur in other implementations.

Application circuitry 1305 includes circuitry such as, but not limited to one or more processors (or processor cores), memory circuitry 1320 (which includes a memory interface), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 1305 may be coupled with or may include memory/storage elements/component/device and may be configured to execute instructions stored in the memory/storage to enable various applications or operating systems to run on the system 1300. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

As examples, the processor(s) of application circuitry 1305 may include a general or special purpose processor, such as an A-series processor (e.g., the A13 Bionic), available from Apple® Inc., Cupertino, CA or any other such processor. The processors of the application circuitry 1305 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc. @ Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 1305 may be a part of a system on a chip (SoC) in which the application circuitry 1305 and other components or devices are formed into a single integrated circuit, or a single package.

The baseband circuitry or processor 1310 may be implemented, for example, as a solder-down substrate including one or more integrated circuits, a single packaged integrated circuit soldered to a main circuit board or a multi-chip module containing two or more integrated circuits. Furthermore, the baseband circuitry or processor 1310 may cause transmission of various resources.

The platform 1300 may also include interface circuitry (not shown) that is used to connect external devices with the platform 1300. The interface circuitry may communicatively couple one interface to another. The external devices connected to the platform 1300 via the interface circuitry include sensor circuitry 1321 and electro-mechanical components (EMCs) 1322, as well as removable memory devices coupled to removable memory circuitry 1323.

A battery 1330 may power the platform 1300, although in some examples the platform 1300 may be mounted deployed in a fixed location, and may have a power supply coupled to an electrical grid. The battery 1330 may be a lithium ion battery, a metal-air battery, such as a zinc-air battery, an aluminum-air battery, a lithium-air battery, and the like. In some implementations, such as in V2X applications, the battery 1330 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components or devices, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a user equipment (UE), comprising: a memory; and one or more processors configured to, when executing instructions stored in the memory, cause the baseband processor to: determine a resource block (RB) set configuration for a multi-slot sidelink transmission, wherein the RB set configuration corresponds to a full bandwidth (BW) or a partial BW for n slots of the multi-slot sidelink transmission; determine a sidelink control information (SCI) configuration, based on the RB set configuration; generate SCI for the multi-slot sidelink transmission based on the SCI configuration, wherein the SCI comprises a first stage SCI in a physical sidelink control channel (PSCCH) and a second stage SCI in a physical sidelink shared channel (PSSCH), wherein the PSCCH and PSSCH are generated for at least a first slot of the n slots; and transmit the multi-slot sidelink transmission over the n slots, wherein the multi-slot sidelink transmission includes the PSCCH and the PSSCH.

Example 2 includes Example 1, wherein the RB set configuration corresponds to a full BW; and the one or more processors are configured to transmit the multi-slot sidelink transmission continuous continuously over the n slots without a gap between the n slots.

Example 3 includes Example 2, wherein an automatic gain control (AGC) symbol is configured for a first symbol of the first slot, and the AGC symbol is an only AGC symbol between the first slot and a physical sidelink feedback channel (PSFCH) of the multi-slot sidelink transmission.

Example 4 includes Example 2, wherein the second stage SCI is transmitted per slot of the n slots and includes HARQ information on a per slot basis.

Example 5 includes Example 2, wherein the first stage SCI is generated for the first slot and a n-1 slots after the first slot.

Example 6 includes Example 5, wherein the first stage SCI includes a channel occupancy time (COT) that is different for at least two of the n slots.

Example 7 includes Example 5, wherein the second stage SCI includes HARQ information on a per slot basis, wherein the HARQ information is unique for each slot of the n slots.

Example 8 includes Example 5, wherein an automatic gain control (AGC) symbol is configured for a first symbol of each of the n slots.

Example 9 includes Example 1, wherein the first stage SCI is only generated for the first slot.

Example 10 includes Example 1, wherein the SCI includes channel occupancy time (COT) information, a time domain slot index information for the n slots, hybrid automatic repeat request (HARQ) identification (ID) information, redundancy version (RV) information, and new data indicator (NDI) information for more than one slot of the n slots.

Example 11 includes Example 10, wherein the second stage SCI is generated for the first slot and includes one or more HARQ IDs for each of the n slots.

Example 12 includes Example 1, wherein the baseband processor is configured for a Mode 1 or a Mode 2 configured grant (CG) sidelink communication.

Example 13 includes Example 1, wherein the RB set configuration corresponds to a partial BW; and the one or more processors are configured to transmit the multi-slot sidelink transmission discontinuously with a gap between at least two of the n slots.

Example 14 includes Example 13, wherein the one or more processors are further configured to perform a clear channel assessment (CCA) during the gap.

Example 15 includes Example 14, wherein when the CCA determines a channel for the multi-slot sidelink transmission is busy, the one or more processors are configured to cancel transmissions in remaining slots of the n slots.

Example 16 includes Example 14, wherein when the CCA determines a channel for the multi-slot sidelink transmission is busy, the one or more processors are configured to cancel transmission of a subsequent slot of the n slots, and perform another CCA during the gap configured in a last symbol of the subsequent slot of the n slots, and continue transmitting the multi-slot sidelink transmission in the n slots when the another CCA determines the channel is clear.

Example 17 includes Example 14, wherein the gap is a 25 microsecond (us) gap or a 16 us gap.

Example 18 includes Example 17, wherein the CCA is a type 2A listen before talk (LBT) procedure for the 25 μs gap, a type 2B LBT procedure for the 16 μs gap, or a type 2C LBT procedure for the 16 μs gap.

Example 19 includes Example 18, wherein the multi-slot sidelink transmission is transmitted according to a channel occupancy time (COT) and the one or more processors are configured to stop multi-slot sidelink transmission to perform the CCA, and subsequently resume transmitting the multi-slot sidelink transmission within a maximum COT (mCOT).

Example 20 includes Example 19, wherein the CCA is the type 2A LBT, the 25 μs gap includes a 16 μs period followed by a 9 μs period, and the one or more processors are configured to: perform sensing of a channel for the multi-slot sidelink transmission for at least 4 μs of the 16 μs period, and perform sensing of the channel for at least 4 μs of the 9 μs period; and determine the channel is clear when the sensing satisfies an energy detection threshold (EDT) during the at least 4 μs of the 16 μs period and at least 4 μs of the 9 μs period.

Example 21 includes Example 19, wherein the CCA is the type 2C LBT and the one or more processors are configured to: stop multi-slot sidelink transmission for the 16 μs gap and resume transmitting the multi-slot sidelink transmission within the mCOT without performing sensing of a channel for the multi-slot sidelink transmission.

Example 22 includes Example 19, wherein the CCA is the type 2B LBT and the one or more processors are configured to: perform sensing of a channel for the multi-slot sidelink transmission for at least 4 μs of the 16 μs gap; and determine the channel is clear when the sensing satisfies an energy detection threshold (EDT) during the at least 4 μs of the 16 μs gap.

Example 23 includes Example 13, wherein the gap is configured in a last symbol of each of the n slots.

Example 24 includes Example 19, wherein the first stage SCI is only configured for the first slot of the n slots and an automatic gain control (AGC) symbol is only configured in a first symbol of the first slot of the n slots.

Example 25 includes Example 19, wherein the first stage SCI and the second stage SCI is configured for all of the n slots, and an automatic gain control (AGC) symbol is only configured in a first symbol of the first slot.

Example 26 includes Example 19, wherein an automatic gain control (AGC) symbol is configured in a first symbol of each of the n slots, and the first stage SCI and the second stage SCI are configured between the AGC symbol and the gap for each of the n slots.

Example 27 includes Example 13, wherein a cyclic prefix (CP) extension of a first symbol of the n slots is configured between the gap of a last symbol of the n slots and the first symbol of the n slots.

Example 28 includes Example 13, wherein a cyclic prefix (CP) post extension of a second to last symbol of the n slots is configured between the second to last symbol of the n slots and the gap of a last symbol of the n slots, wherein the gap is configured in a last symbol of the n slots.

Example 29 includes Example 13, wherein the gap is configured in a last symbol of each of the n slots, and the gap is greater than 25 microseconds.

Example 30 is a user equipment (UE), comprising: a memory; and one or more processors configured to, when executing instructions stored in the memory, cause the UE to: configure a mode 1 sidelink (SL) resource allocation based on a downlink control information (DCI) format 3_0; determine, from the DCI format 3_0, n slots for multi-slot sidelink transmissions, and determine, from the DCI format 3_0, a clear channel assessment (CCA) configuration and a gap configuration for each of the n slots; and perform one or more CCA procedures according to the CCA configuration and gap configuration on a per slot basis of the n slots.

Example 31 includes Example 30, wherein a sidelink control information (SCI) including one or more of a first stage sidelink control information (SCI) and a second stage SCI are configured for the n slots.

Example 32 includes Example 30, wherein the one or more CCA procedures are performed for less than all of the n slots.

Example 33 includes Example 30, wherein the one or more CCA procedures include a type 1 listen before talk (LBT) procedure, a type 2A LBT procedure, a type 2B LBT procedure, or a type 2C LBT procedure.

Example 34 is a user equipment (UE), comprising: a memory; and one or more processors configured to, when executing instructions stored in the memory, cause the UE to: determine a resource block (RB) set configuration for a multi-slot sidelink transmission, wherein the RB set configuration corresponds to a full bandwidth (BW) for n slots of the multi-slot sidelink transmission; determine a sidelink control information (SCI) configuration, based on the RB set configuration; generate SCI for the multi-slot sidelink transmission based on the SCI configuration, wherein the SCI comprises a first stage SCI in a physical sidelink control channel (PSCCH) and a second stage SCI in a physical sidelink shared channel (PSSCH), wherein the PSCCH and PSSCH are generated for at least a first slot of the n slots; and transmit the multi-slot sidelink transmission over the n slots continuously, wherein the multi-slot sidelink transmission includes the PSCCH and the PSSCH.

Example 35 is a user equipment (UE), comprising: a memory; and one or more processors configured to, when executing instructions stored in the memory, cause the UE to: determine a resource block (RB) set configuration for a multi-slot sidelink transmission, wherein the RB set configuration corresponds to a partial BW for n slots of the multi-slot sidelink transmission; determine a sidelink control information (SCI) configuration, based on the RB set configuration; generate SCI for the multi-slot sidelink transmission based on the SCI configuration, wherein the SCI comprises a first stage SCI in a physical sidelink control channel (PSCCH) and a second stage SCI in a physical sidelink shared channel (PSSCH), wherein the PSCCH and PSSCH are generated for at least a first slot of the n slots; and transmit the multi-slot sidelink transmission over the n slots discontinuously, wherein the multi-slot sidelink transmission includes the PSCCH and the PSSCH.

A method as substantially described herein with reference to each or any combination substantially described herein, comprised in examples 1-35, and in the Detailed Description.

A non-transitory computer readable medium as substantially described herein with reference to each or any combination substantially described herein, comprised in examples 1-35, and in the Detailed Description.

A wireless device configured to perform any action or combination of actions as substantially described herein, comprised in examples 1-35, and in the Detailed Description.

An integrated circuit configured to perform any action or combination of actions as substantially described herein, comprised in examples 1-35, and in the Detailed Description.

An apparatus configured to perform any action or combination of actions as substantially described herein, comprised in examples 1-35, and in the Detailed Description.

A baseband processor configured to perform any action or combination of actions as substantially described herein, comprised in examples 1-35, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components or devices (assemblies, devices, circuits, systems, etc.), the terms (including a reference to a “means”) used to describe such components or devices are intended to correspond, unless otherwise indicated, to any component, device, or structure which performs the specified function of the described component or device (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements, devices, or components throughout, and wherein the illustrated structures and devices are not necessarily drawn to scale. As utilized herein, terms “device,” “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.” Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor of a user equipment (UE), comprising:
one or more processors configured to,
determine a resource block (RB) set configuration for a multi-slot sidelink transmission with n slots;
determine a sidelink control information (SCI) configuration, based on the RB set configuration;
generate SCI for the multi-slot sidelink transmission based on the SCI configuration, wherein the SCI configuration comprises a first stage SCI in a physical sidelink control channel (PSCCH) and a second stage SCI in a physical sidelink shared channel (PSSCH); and
cause transmission of the multi-slot sidelink transmission over the n slots, wherein the multi-slot sidelink transmission includes the SCI configuration in the PSCCH and the PSSCH.

2. The baseband processor of claim 1, wherein the RB set configuration corresponds to a full BW for the n slots of the multi-slot sidelink transmission; and
the one or more processors are configured to cause transmission of the multi-slot sidelink transmission continuously over the n slots without a gap between the n slots.

3. The baseband processor of claim 2, wherein an automatic gain control (AGC) symbol is configured for a first symbol of a first slot of the n slots, and the AGC symbol is an only AGC symbol between the first slot and a physical sidelink feedback channel (PSFCH) of the multi-slot sidelink transmission.

4. The baseband processor of claim 2, wherein the second stage SCI is transmitted per slot of the n slots and includes HARQ information on a per slot basis.

5. The baseband processor of claim 2, wherein the first stage SCI is generated for a first slot of the n slots and a n-1 slots of the n slots after the first slot.

6. The baseband processor of claim 5, wherein the first stage SCI includes a channel occupancy time (COT) that is different for at least two of the n slots.

7. The baseband processor of claim 5, wherein the second stage SCI includes HARQ information on a per slot basis, wherein the HARQ information is unique for each slot of the n slots.

8. The baseband processor of claim 1, wherein an automatic gain control (AGC) symbol is configured for a first symbol of each of the n slots.

9.-35. (canceled)

36. A user equipment (UE), comprising:
a memory; and
one or more processors configured to, when executing instructions stored in the memory, cause the UE to:
determine a resource block (RB) set configuration for a multi-slot sidelink transmission with n slots;
determine a sidelink control information (SCI) configuration, based on the RB set configuration;
generate SCI for the multi-slot sidelink transmission based on the SCI configuration, wherein the SCI configuration comprises a first stage SCI in a physical sidelink control channel (PSCCH) and a second stage SCI in a physical sidelink shared channel (PSSCH); and
transmit, by a radio frequency (RF) circuitry, the multi-slot sidelink transmission over the n slots, wherein the multi-slot sidelink transmission includes the SCI configuration in the PSCCH and the PSSCH.

37. The UE of claim 36, wherein, the RB set configuration corresponds to a partial BW for the n slots of the multi-slot sidelink transmission; and
the one or more processors are configured to cause the UE to transmit the multi-slot sidelink transmission discontinuously with a gap between at least two of the n slots.

38. The UE of claim 37, wherein the one or more processors are configured to perform a clear channel assessment (CCA) during the gap, and wherein
when the CCA determines a channel for the multi-slot sidelink transmission is busy, the one or more processors are configured to cause the UE to cancel transmissions in remaining slots of the n slots.

39. The UE of claim 37, wherein the one or more processors are configured to perform a clear channel assessment (CCA) during the gap, and wherein
when the CCA determines a channel for the multi-slot sidelink transmission is busy, the one or more processors are configured to cancel transmission of a subsequent slot of the n slots, and perform another CCA during the gap configured in a last symbol of the subsequent slot of the n slots, and continue transmitting the multi-slot sidelink transmission in the n slots when the another CCA determines the channel is clear.

40. The UE of claim 37, wherein the gap is configured in a last symbol of each of the n slots.

41. The UE of claim 40, wherein the first stage SCI and the second stage SCI is configured for all of the n slots, and an automatic gain control (AGC) symbol is only configured in a first symbol of a first slot of the n slots.

42. The UE of claim 40, wherein an automatic gain control (AGC) symbol is configured in a first symbol of each of the n slots, and the first stage SCI and the second stage SCI are configured between the AGC symbol and the gap for each of the n slots.

43. A method for a user equipment (UE), the method comprising:
determining a resource block (RB) set configuration for a multi-slot sidelink transmission with n slots;
determining a sidelink control information (SCI) configuration, based on the RB set configuration;
generating SCI for the multi-slot sidelink transmission based on the SCI configuration, wherein the SCI configuration comprises a first stage SCI in a physical sidelink control channel (PSCCH) and a second stage SCI in a physical sidelink shared channel (PSSCH); and
transmitting the multi-slot sidelink transmission over the n slots, wherein the multi-slot sidelink transmission includes the SCI configuration in the PSCCH and the PSSCH.

44. The method of claim 43, wherein the multi-slot sidelink transmission is transmitted according to a channel occupancy time (COT), and the multi-slot sidelink transmission are transmitted discontinuously with a gap between at least two of the n slots, and the method includes:
stopping the multi-slot sidelink transmission during the gap;
performing a clear channel assessment (CCA) during the gap; and
resuming transmission of the multi-slot sidelink transmission within a maximum COT (mCOT).

45. The method of claim 44, wherein:
the gap is a 25 microsecond (us) gap that includes a 16 μs period followed by a 9 μs period, and
the CCA is a type 2A listen before talk (LBT) procedure, and the method includes:
performing the CCA for at least 4 μs of the 16 μs period, and performing the CCA for at least 4 μs of the 9 μs period; and
determining a channel for the multi-slot sidelink transmission is clear when the CCA satisfies an energy detection threshold (EDT) during the at least 4 μs of the 16 μs period and at least 4 μs of the 9 μs period.

46. The method of claim 44, wherein:
the gap is a 16 microsecond (μs) gap, and
the CCA is a type 2C listen before talk (LBT) procedure, and the method includes:
stopping the multi-slot sidelink transmission for the 16 μs gap and resume transmitting the multi-slot sidelink transmission within the mCOT without performing the CCA.

47. The method of claim 44, wherein:
the gap is a 16 microsecond (μs) gap, and
the CCA is a type 2B listen before talk (LBT) procedure, and the method includes:
performing the CCA for at least 4 μs of the 16 μs gap; and
determining a channel for the multi-slot sidelink transmission is clear when the CCA satisfies an energy detection threshold (EDT) during the at least 4 μs of the 16 μs gap.
